(19) United States
(12) Patent Application Publication
(10) Pub. No.: US 2004/0061294 A1
(43) Pub. Date: Apr. 1, 2004

(54) Wheel attachment apparatus

(76) Inventor: William G. Flanigan JR., Malta, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/260,147

(22) Filed: Sep. 27, 2002

(51) Int. Cl. B62B 19/00

(52) U.S. Cl. 280/8

(57) ABSTRACT

An apparatus for attachment to a wheel, a coupling device for attachment to a wheel, a wheeled cart, and a method for using the apparatus is disclosed. The apparatus has a sliding surface and a coupling system for releasably attaching the sliding surface to the wheel.

### FIELD OF INVENTION

This invention relates generally to the field of wheels and, more particularly, to an apparatus which attaches around a wheel thereby protecting the wheel and improving the wheel's mobility over rough surfaces such as snow, slush, etc.

### BACKGROUND OF INVENTION

Carts, whether they are grocery, shopping, or other types of wheeled carts, typically have numerous wheels. Whether the wheels are a standard (i.e., non-steerable) wheel, or a steerable wheel such as a caster wheel, the wheel and its parts frequently wear out due to the rough conditions they are submitted to. Being that the carts are often outside, the various parts of the wheels are submitted to all types of inclement weather, temperature, moisture, surface conditions, UV, as well as abuse by the end user. As a result, the most frequent maintenance and cost item for carts is, far and away, the repair or replacement of the wheel assembly.

In northern climes, in particular, wheeled carts are subjected to an additional impediment. Namely: snow. Whether it is a freshly fallen snow or a poorly maintained parking lot, snow and slush, in any amount, makes the locomotion of a wheeled cart certainly more difficult, if not impossible. Frequent is the sight in a parking lot of a consumer struggling to plow their cart through the snow with much consternation and frustration. Still other consumers will, in time, simply abandoned their cart, leaving the carts cluttered throughout the parking lot, leaving additional work for employees to retrieve the carts, etc. Rather than attempting the fool's errand of trying to get their cart from store to vehicle, many consumers merely retrieve their parked vehicle from its parked location and drive it to the front of the store to load their goods. This results in the all to common occurrence of a plethora of vehicles jammed in front of a store, with or without their emergency flashers “on”, creating the classic parking lot bottleneck, which aside from being disruptive to the flow of traffic and commerce, often occurs in a “no parking” fire lane. Still, other consumers altogether forego potential trips to the market in order to avoid this unnecessary, time consuming physical labor at the entrance of a store.

Accordingly, there is a need in the field of wheels, caster wheels, and wheeled carts for improvement in both protecting the various parts of the wheels and in traveling over rough surfaces, such as snow.

### SUMMARY OF INVENTION

The present invention provides an apparatus and method for use with wheels.

A first general aspect of the invention provides an apparatus for attachment to a wheel comprising:

a sliding surface; and

a coupling system for releasably attaching said sliding surface to said rotatable wheel.

A second general aspect of the invention provides an apparatus for releasable attachment to a caster wheel comprising:

a coupling for releasable attachment to said caster wheel; and

a housing operatively attached to said coupling for substantially surrounding said caster wheel.

A third general aspect of the invention provides an apparatus for attachment to a wheel, said wheel having a first axis of rotation about an axle, said wheel further having a collar attached to a flange operationally attached to said axle of said wheel, said collar having a second axis of rotation substantially perpendicular to said first axis, said apparatus comprising:

a coupling device operationally attached to said housing;

said housing having a first substantially planar surface, wherein said wheel rotates freely about said first axis of rotation within said housing; and

said housing and said wheel, in combination, rotate freely about said second axis.

A fourth general aspect of the invention provides an apparatus for attachment to a wheel, said wheel having a first axis of rotation about an axle, said wheel further having a collar attached to a flange operationally attached to said axle of said wheel, said collar having a second axis of rotation perpendicular to said first axis, said apparatus comprising:

a coupling device operationally attached to said collar and to a housing;

said housing having a substantially planar surface, said planar surface having an opening therein through which a portion of said wheel extends;

said planar surface having a first end and a second end, at least one of said first and second ends having an upturned portion;

said wheel rotating freely about said first axis of rotation within said housing; and

said housing and said wheel, in combination, rotating freely about said second axis.

A fifth general aspect of the invention provides a coupling device for attachment to a wheel, said wheel having a first axis of rotation about an axle, said wheel further having a collar rotatably attached to a flange operationally attached to said axle of said wheel, said collar having a second axis of rotation substantially perpendicular to said first axis, wherein said coupling device is operatively attached to a wheel housing;

wherein said wheel rotates freely about said first axis of rotation with said wheel housing;

said wheel housing and said wheel, in combination, rotate freely about said second axis; and

wherein said coupling device straddles said flange.

A sixth general aspect of the invention provides a wheeled cart comprising:

a plurality of wheels;

a container attached to said plurality of wheels;

at least one ski; and

a coupling device for releasably attaching said at least one ski to at least one of said plurality of wheels.

A seventh general aspect of the invention provides a wheeled cart comprising:

a plurality of wheels;

a container operatively attached to said plurality of wheels;

said plurality of wheels having a first axis of rotation about an axle, said plurality of wheels further having a collar attached to a flange operationally attached to said axle of said plurality of wheels, said collar having a second axis of rotation substantially perpendicular to said first axis;

a coupling device operatively attached to said flange and to a housing;

said housing having a substantially planar surface;

at least one of said plurality of wheels being able to rotate freely about said first axis of rotation within said housing; and

said housing and at least one of said plurality of wheels, in combination, being able to rotate freely about said second axis.

An eighth general aspect of the invention provides a method to facilitate movement of a wheeled cart across a traveling surface comprising:

providing a plurality of wheels;

attaching a container to said plurality of wheels;

providing at least one ski; and

releasably attaching a coupling device to said at least one ski and to at least one of said plurality of wheels.

The foregoing and other features of the invention will be apparent from the following more particular description of various embodiments of the invention.

### BRIEF DESCRIPTION of DRAWINGS

Some of the embodiments of this invention will be described in detail, with reference to the following figures, wherein like designations denote like members, wherein:

FIG. 1 depicts a perspective view of shopping cart with two wheel attachment apparatuses attached thereto, in accordance with an embodiment of the present invention;

FIG. 2 depicts a side elevation view of a caster wheel in the related art;

FIG. 3A depicts a front elevation view of a portion of a wheel attachment apparatus, in accordance with an embodiment of the present invention;

FIG. 3B depicts a rear elevation view of a portion of a wheel attachment apparatus, in accordance with an embodiment of the present invention;

FIG. 4 depicts a side elevation view of a wheel attachment apparatus, in accordance with an embodiment of the present invention;

FIG. 5 depicts a front sectional view of a wheel attachment apparatus, in accordance with an embodiment of the present invention;

FIG. 6 depicts a bottom plan view of wheel attachment apparatus, in accordance with an embodiment of the present invention;

FIG. 7A depicts a front elevation view of an embodiment of a wheel attachment apparatus, in accordance with an embodiment of the present invention;

FIG. 7B depicts a front elevation view of an alternative embodiment of a wheel attachment apparatus, in accordance with an embodiment of the present invention;

FIG. 7C depicts a front elevation view of an alternative embodiment of a wheel attachment apparatus, in accordance with an embodiment of the present invention;

FIG. 7D depicts a front elevation view of an alternative embodiment of a wheel attachment apparatus, in accordance with an embodiment of the present invention;

FIG. 7E depicts a front elevation view of an alternative embodiment of a wheel attachment apparatus, in accordance with an embodiment of the present invention;

FIG. 8A depicts a partial top plan view of a portion of a wheel attachment apparatus, in accordance with an embodiment of the present invention;

FIG. 8B depicts a partial top plan view of a portion of an alternative embodiment of a wheel attachment apparatus, in accordance with an embodiment of the present invention;

FIG. 8C depicts a partial top view of a portion of an alternative embodiment of a wheel attachment apparatus, in accordance with an embodiment of the present invention;

FIG. 8D depicts a partial top view of a portion of an alternative embodiment of a wheel attachment apparatus, in accordance with an embodiment of the present invention;

FIG. 9 depicts a side elevation view of an alternative embodiment of a wheel attachment apparatus, in accordance with an embodiment of the present invention; and

FIG. 10 depicts a top perspective view of an alternative embodiment of a wheel attachment apparatus, in accordance with an embodiment of the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

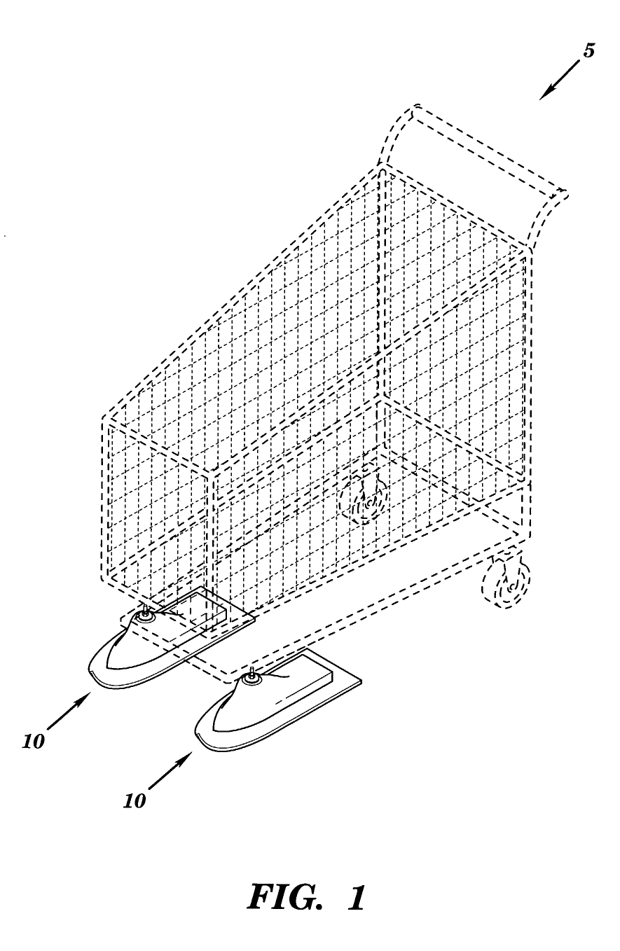

As shown in FIG. 1, a top perspective view of an embodiment present invention, a wheel attachment apparatus is generally designated as 10. A typical shopping or grocery cart 5 is shown in phantom wherein at least one of the wheel attachment apparatuses 10 are attached thereto. The cart 5 typically includes a container of some sort for holding objects. Alternatively, any number (e.g., one, four, etc.) of wheel attachment apparatuses 10 may be attached to the cart 5.

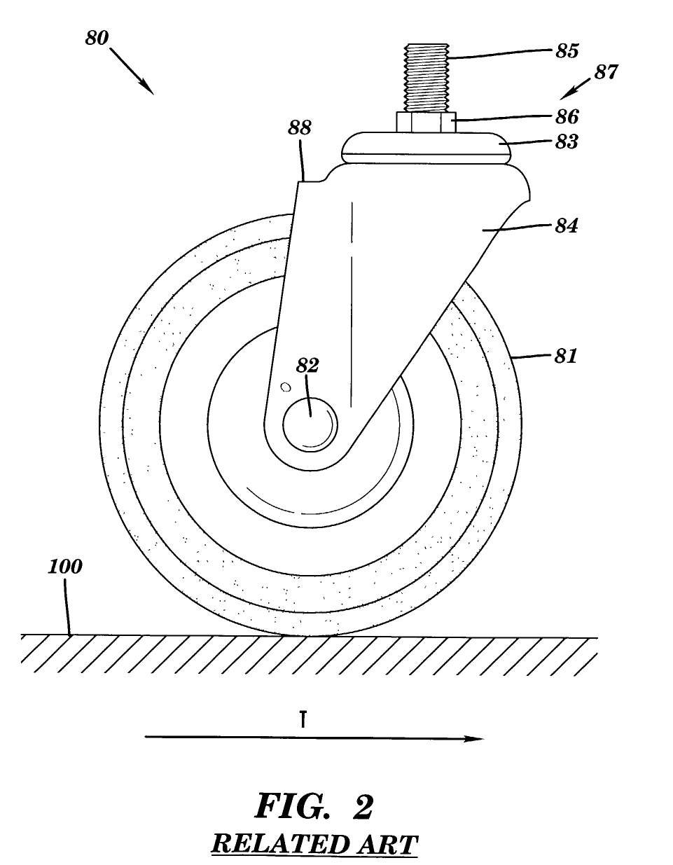

FIG. 2 shows a side elevation view of a caster wheel in the related art, similar to those typically used on grocery or shopping carts 5. The wheel is denoted as 80. The tread 81 of the wheel 80 contacts a surface 100. The wheel 80 rotates around an axle 82, which, via a flange 84, is connected to a bearing 83 and threaded rod 85. A bolt 86 is attached to the threaded rod 85. The flange 84 is typically made of stamped metal, and often has a horizontal flaring between its connection with the axle 82 and its transition into a predominantly horizontal element. Resting atop and connected to this horizontal element is a collar 87 of some configuration. Typically, the collar 87 includes a horizontal bearing 83. Various types of bearings 83 may be used. The wheel 80 is typically attached to a cart 5 via the threaded rod 85 and bolt 86. The direction of travel of the caster wheel 80, when the wheel 80 is operating correctly, is denoted by directional arrow “T”. On the rear portion of the flange 84, above the tread 81, is typically a horizontal bearing shelf 88. The use of the bearing shelf 88 in the present invention will become apparent in subsequent discussion.

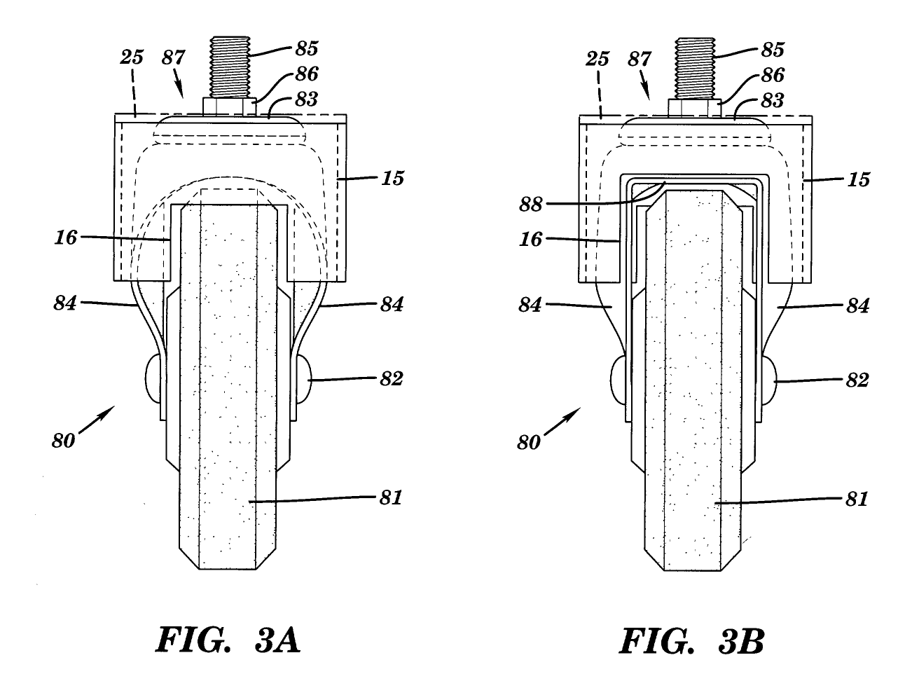

FIG. 3A and FIG. 3B are front and rear elevation views, respectively, of a portion of the present invention. Extending from the top of the bearing 83 and flange 84 is a threaded rod 85, or stud, and bolt 86. The wheel 80 is typically attached to a connector plate (not shown) on a cart 5 at the threaded rod 85 and bolt 86. A caster wheel 80, such as the one shown in FIG. 2, is able to steer (i.e., rotate about a vertical axis) because of the addition of the bearing 83. Other wheels 80 are not steerable, but are fixed (not shown). That is while the tread 81 of a fixed wheel certainly can rotate around a horizontal axis and travel on a surface 100; they cannot steer and rotate freely about a vertical axis as a caster wheel 80 can. These non-steerable wheels 80 (not shown) do not require a bearing 83 at the top of the flange 84. Typically, a cart 5 has four wheels 80 attached. Often, the front two wheels 80 are caster wheels 80, while the back two wheels of the cart 5 are of the non-steerable configuration. Attached to the wheel 80 is a coupling 15. The coupling 15 is attached to the flange 84 portion of the wheel 80. The coupling 15, which can be many shapes including cylinder or square-shaped, has a notch 16 removed from each side (i.e., front and back) of the coupling 15 in order to more accurately fit over the flange 84 and tread 81. For example, on the front portion of the wheel 80 (see FIG. 3A) the notch 16 is removed, in part, to allow clearance for the tread 81 and thus free and full rotation of the wheel 80. On the rear portion of the wheel 80, the removed notch 16 (See FIG. 3B) allows a portion of the coupling 15 to bear upon the bearing shelf 88. An additional bearing 25, such as a needle roller thrust bearing, can optionally be added to the top of the coupling 15 to further enhance rotation of the wheel 80 between the cart 5. The coupling 15, or coupling means, is a coupling system which allows other features of the apparatus 10 to attach to the wheel 80. The coupling 15 can be fixed to the wheel flange 84 (e.g., welded, bolted, etc.) or releasably attached to the wheel flange 84. Alternatively, the coupling system 15 could be attached to the wheel 80 at other locations, including the axles 82. In another embodiment, the coupling 15 could have a quick release device (not shown) whereby the coupling 15 can be attached to the wheel 80, and, if desired, can be quickly released from its attachment to the wheel 80. With the caster wheel 80 configuration the coupling 15, while being adjacent to the bearing 83, typically should not touch or impinge on the free rotation of the bearing 83. This spacing between the bearing 83 and coupling 15 allows the caster wheel 80 to still freely steer (i.e., rotate about the vertical axis). While the configuration of the coupling 15 in FIGS. 3A and 3B is shown as a pipe-shaped cylinder, the coupling 15 can be other shapes that fit around the flange 84. For example, the coupling 15 may be molded and form fitted around the shape of the flange 84. The coupling 15 allows for various elements, such as a housing, ski, etc. to be connected to the wheel 80, without impeding the rotation and steering of the wheel 80.

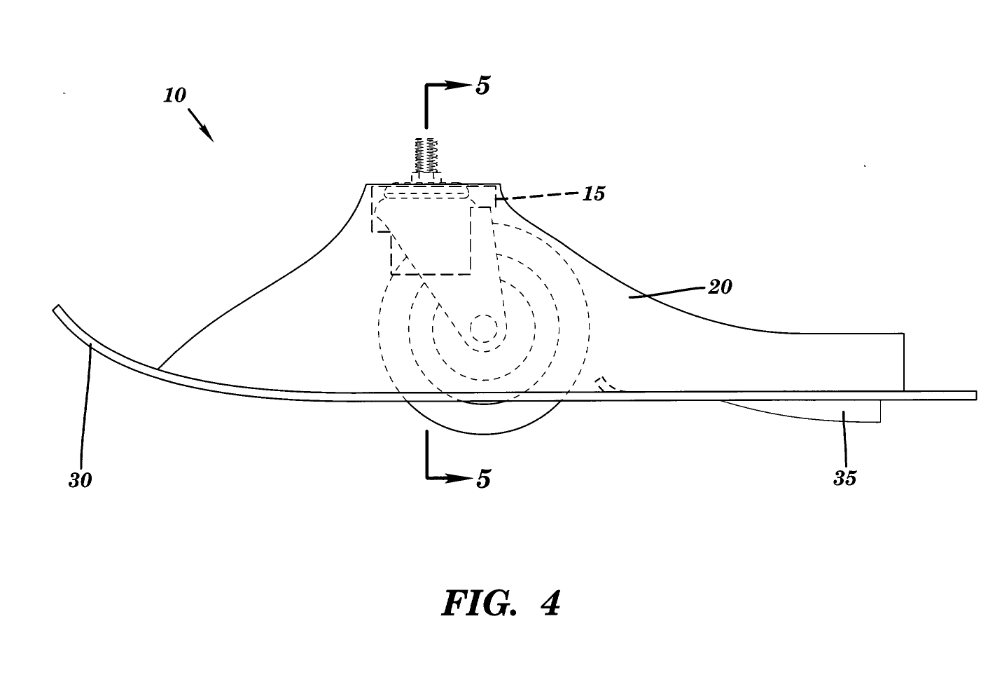

FIG. 4 depicts a side elevation view of an embodiment of the wheel attachment apparatus 10, in accordance with the present invention. A housing 20 is attached to the coupling 15 by various means such as welding, bolts, removable attachments, etc. The housing 20, which can be a plurality of shapes, either partially or substantially surrounds the wheel 80 and the various components of the wheel 80. In order to improve the capability of the wheel 80 to travel through snow, slush, sand, and the like the housing 20 can extend around the wheel 80 both fore and aft. For example, the housing 20 can be navicular (i.e., boat-shaped) in shape, or in the alternative, could be an upside-down navicular shape. The housing 20 can be round or any shape that helps protect the wheel 80 and improve the wheel's 80 travel through snow, slush, etc. Attached to the bottom of the housing 20, is a sliding surface 30. As with the housing 20, the sliding surface 30 can have a plurality of shapes all designed to cut and slide through snow, slush, and the like. The combination of the housing 20 and sliding surface 30 surround the wheel 80 further protecting it from the various elements (i.e., UV, temperature, moisture, physical contact, etc.). The sliding surface 30 can have a front portion which is upturned thereby improving mobility through the snow. Alternatively, the sliding surface 30 can have its entire perimeter upturned, thereby improving mobility regardless of which direction the apparatus 10 is pointed. To further improve steering and control in snow, a skeg 35, or rudder, can extend off of the ventral surface of the sliding surface 30. The sliding surface 30 can extend longitudinally along the direction of travel of the wheel 80 in substantially rectangular shape, such as a ski. In an alternative embodiment, the sliding surface 30 rather than being predominantly rectangular or square in shape, can be circular or elliptical. The full perimeter, or outside edge, of the sliding surface 30 would be upturned. Thus, in this embodiment of the apparatus 10, the sliding surface 30 would look similar to a children's plastic snow sledding disks (i.e., sometimes referred to as a “coaster” or a “disk”). Although the housing 20 and sliding surface 30 are shown in FIG. 4 as discrete elements, the housing 20 and sliding surface 30 can be formed such that they are one continuous unit.

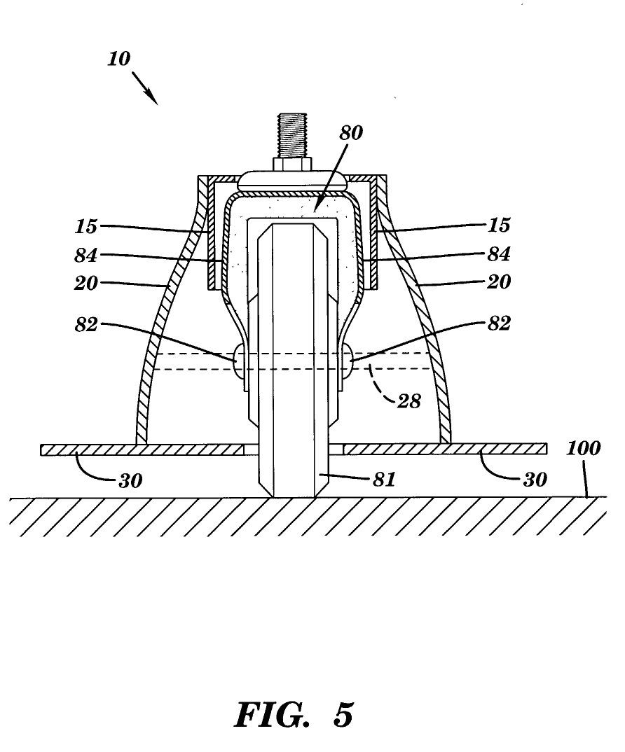

A section elevation view taken along line “5-5” of FIG. 4 is shown in FIG. 5 depicting the one embodiment of the apparatus 10. In this embodiment, there is not the optional additional bearing 25 above the coupling 15. The coupling 15 is attached to the flange 84 of the wheel 80. The coupling 15 is attached to the housing 20, which, in turn, connects to the sliding surface 30. The tread 81 of the wheel 80 extends partially beyond the sliding surface 30 in order to contact the surface 100 (e.g., pavement) in good weather. In the event of snow, or other poor surface conditions, the sliding surface 30 would alternatively contact the surface 100. An attachment 28 can further be extended from the axles 82 in order to improve the rigid connection between the apparatus 10 and the wheel 80. Alternatively, the housing 20 may extend to the edge of the sliding surface 30.

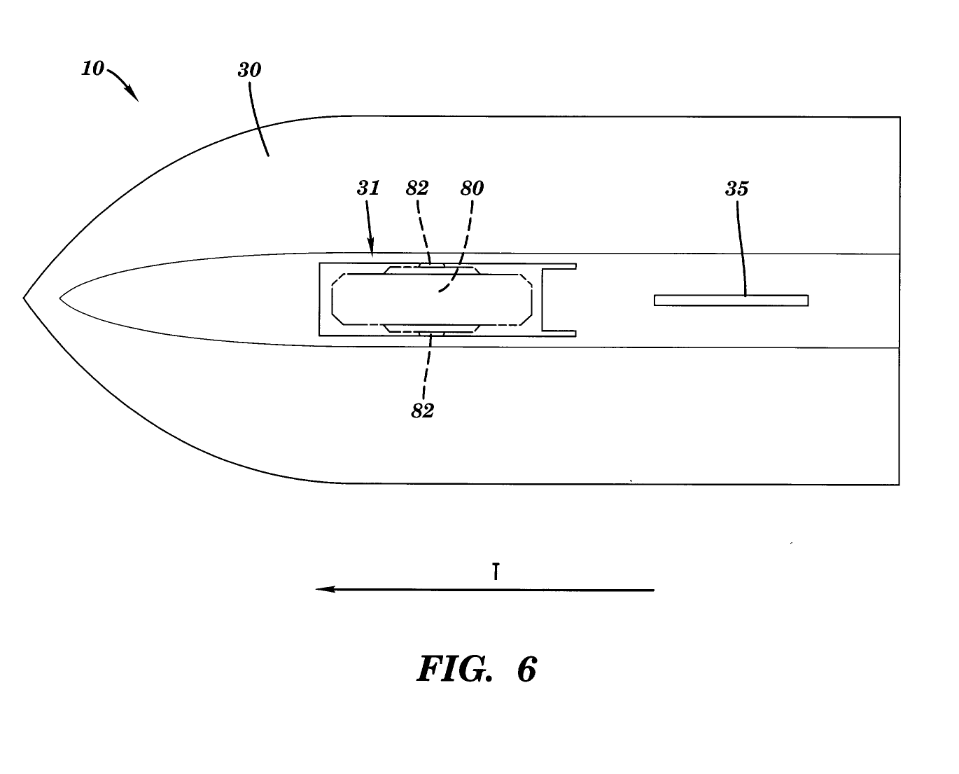

FIG. 6 depicts a bottom plan view of the wheel attachment apparatus 10, in accordance with the present invention. The sliding surface 30 has an opening 31 from which a portion of the wheel 80 extends. A skeg 35, or rudder, can be extended off the back of the sliding surface. The direction of travel of the apparatus 10 and wheel 80 is shown by directional arrow “T”. At the front end of the sliding surface 30 is an upturned portion, creating a sliding surface 30 similar to a ski. At the rear end of the wheel opening 31 a portion of the sliding surface 30 is slightly upturned into the housing 20 cavity thereby helping cut down on drag in the snow and lessening any intrusion of material (e.g., snow, slush, gravel, sand, etc.) into the cavity of the apparatus 10. The sliding surface 30 in this embodiment is corrugated. That is, the center longitudinal portion of the sliding surface 30 (i.e., section closest to the wheel 80) is lower towards a driving surface than the two outer sections of the sliding surface 30. This corrugated sliding surface 30 improves mobility of the wheel 80. This configuration is similar to the ski attachment used on the front of some snowmobiles.

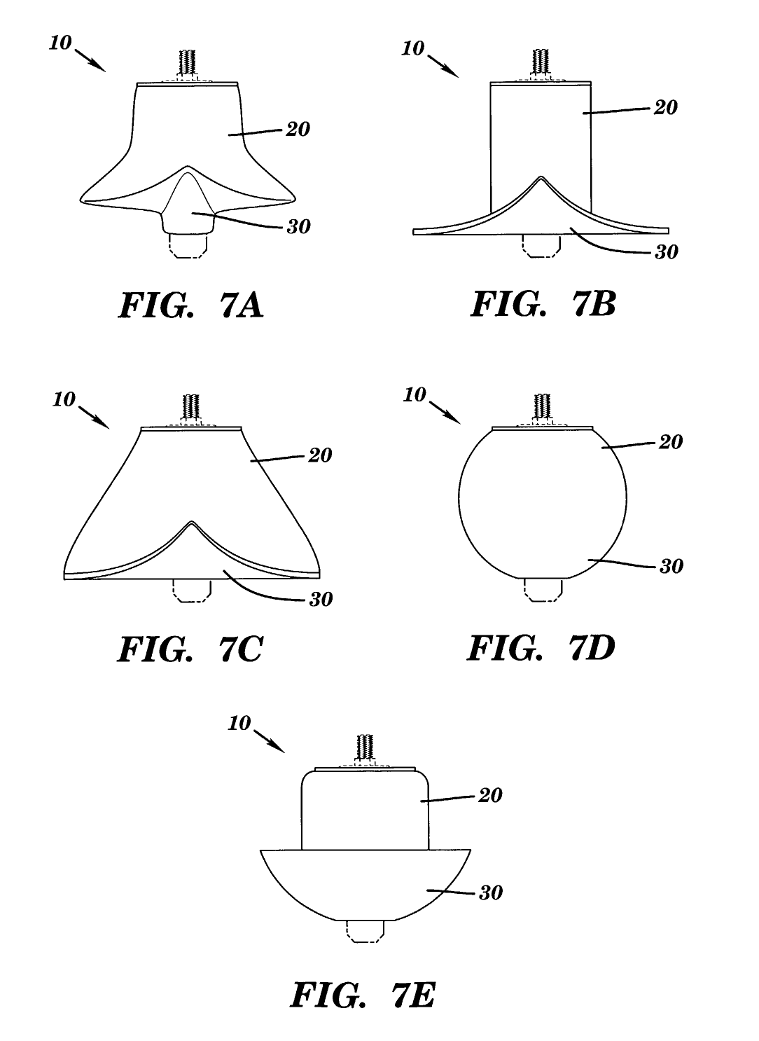

FIGS. 7A, 7B, 7C, 7D, and 7E depict front elevation views of numerous embodiments of the wheel attachment apparatus 10, in accordance with the present invention. There are numerous configurations for the housing 20 and sliding surfaces 30. FIG. 7A shows a housing 20 that blends into, or is integral with, the sliding surface 30. The sliding surface 30, in this embodiment, is not entirely flat, but is corrugated. FIG. 7A shows the same embodiment as depicted in FIG. 6. FIG. 7B depicts a sliding surface 30 which has an upturned front portion, resembling a snow ski. FIG. 7C depicts a housing 20 that flares and extends to the perimeter of the sliding surface 30. FIG. 7D depicts a housing 20 and sliding surface 30 that are fully integrated. That is, the housing 20 and sliding surface 30 are one spheroid unit. FIG. 7E depicts an apparatus 20 wherein the sliding surface 30 is up-turned on its entire perimeter.

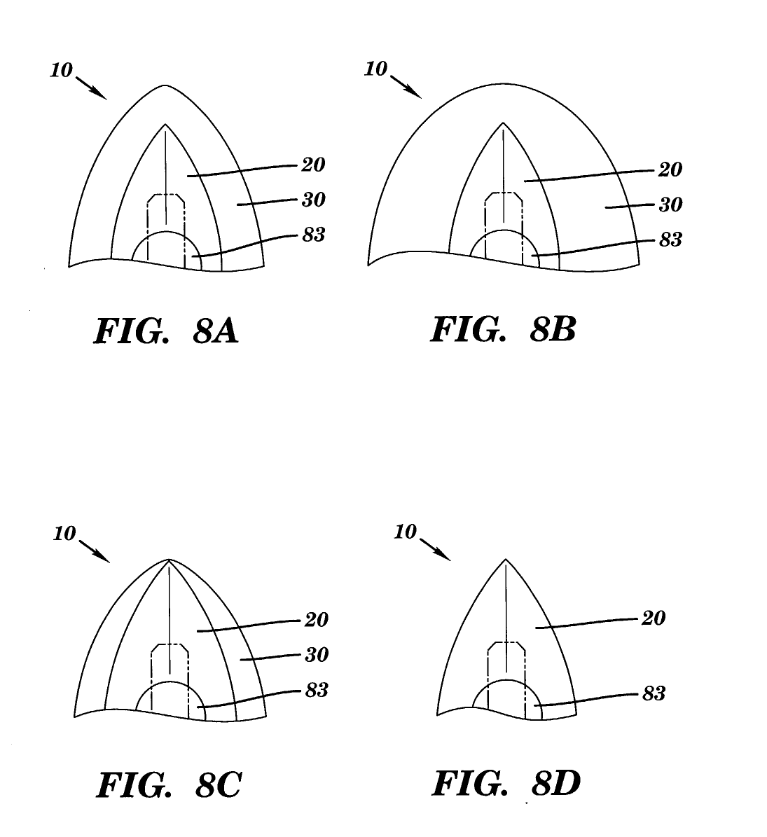

FIGS. 8A, 8B, 8C and 8D depict top plan views of the front portion of various embodiments of the apparatus 10. Although various triangular shapes with convex leading edges are depicted on the front, up-turned portion of the apparatus 10, other shapes can be employed. For example, the up-turned portion can be square, or triangular with concave leading edges.

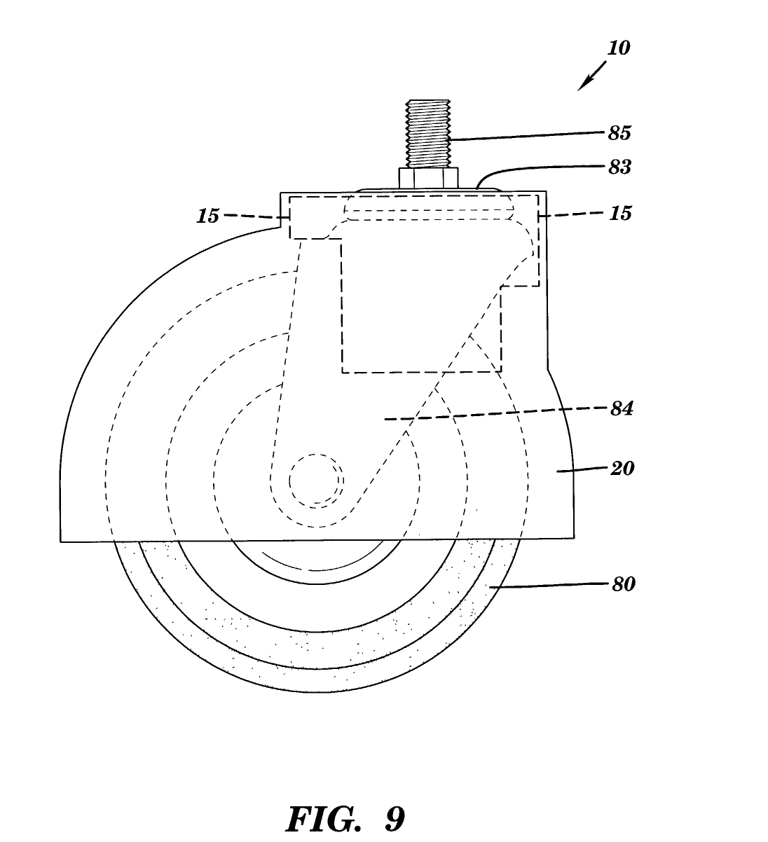

FIG. 9 depicts a side elevation view of another embodiment of a wheel attachment apparatus 10, in accordance with the present invention. Similar to the above mentioned embodiments, this embodiment contains a coupling 15 (shown in phantom) connected to the flange 84 (shown in phantom) of the wheel 80. In contrast, this embodiment is devoid of a sliding surface 30 of any kind and only has a housing 20. The housing 20 similarly can have a myriad of shapes and configurations to facilitate the transport through snow, slush, etc. of the wheel 80 and cart 5 and to increase protection of the wheel 80.

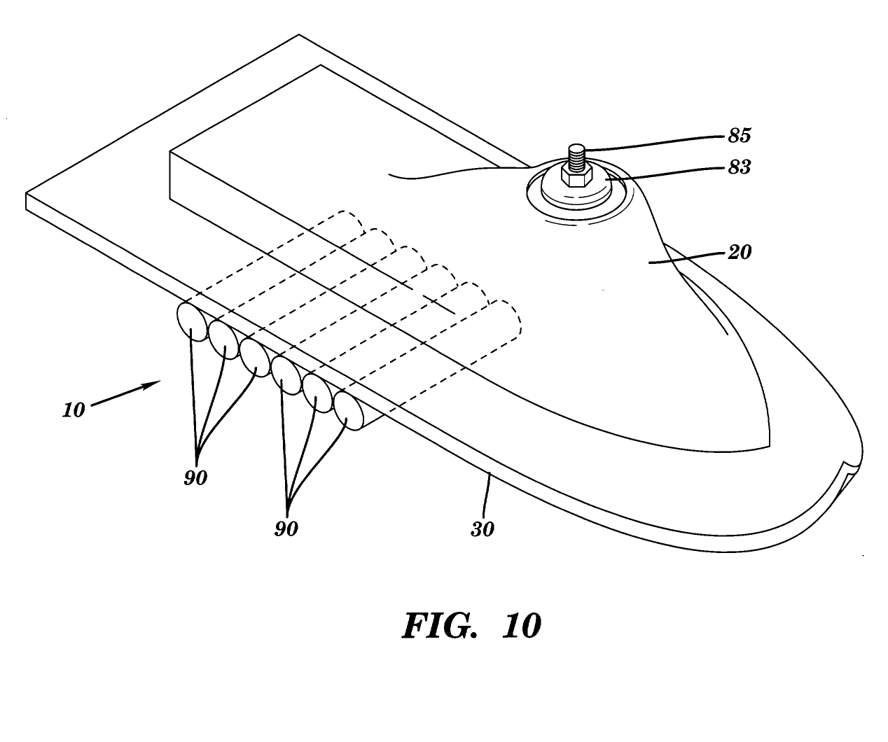

FIG. 10 depicts a top perspective view of another embodiment of a wheel attachment apparatus 10, in accordance with the present invention. In lieu of, or in addition to, a wheel 80, a plurality of roller bearings 90 is placed along the ventral side of the apparatus 10 for rolling purposes. The wheel 80 may be fixed, retractable vertically within the sliding surface 30, or omitted altogether.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. An apparatus for attachment to a wheel comprising:
a sliding surface; and
a coupling system for releasably attaching said sliding surface to said wheel.

2. An apparatus as in claim 1, wherein said wheel is a caster wheel.

3. An apparatus as in claim 1, wherein said coupling system includes a quick release device.

4. An apparatus as in claim 1, further comprising a housing operatively attached to said coupling system.

5. An apparatus as in claim 4, wherein said housing substantially surrounds said wheel.

6. An apparatus as in claim 1, wherein said sliding surface has an opening therein through which a portion of said wheel extends.

7. An apparatus as in claim 1, wherein said sliding surface is a ski.

8. An apparatus as in claim 1, wherein said sliding surface has at least one of a skeg and a rudder on a ventral surface.

9. An apparatus as in claim 4, wherein said housing further comprises:
a first substantially planar surface;
a second substantially planar surface;
wherein said first substantially planar surface and said second substantially planar surface are substantially perpendicular to a tread of said wheel.

10. An apparatus as in claim 9, wherein said first substantially planar surface and said second substantially planar surface meet in a junction in front of the direction of travel of said wheel.

11. An apparatus as in claim 4, wherein said housing is attached to said sliding surface.

12. An apparatus as in claim 4, wherein said sliding surface extends laterally beyond said housing.

13. An apparatus as in claim 1, wherein said sliding surface has a corrugated surface.

14. An apparatus as in claim 1, wherein said sliding surface is in the shape selected from the group consisting of circular and elliptical.

15. An apparatus as in claim 1, wherein at least one outer edge of said sliding surface is upturned.

16. An apparatus as in claim 1, wherein:
said wheel engages a traveling surface upon which said wheel travels; and
said sliding surface being substantially parallel to said traveling surface.

17. An apparatus for releasable attachment to a caster wheel comprising:
a coupling for releasable attachment to said caster wheel; and
a housing operatively attached to said coupling for substantially surrounding said caster wheel.

18. An apparatus as in claim 17, wherein said coupling is a quick release device.

19. An apparatus for attachment to a wheel, said wheel having a first axis of rotation about an axle, said wheel further having a collar attached to a flange operationally attached to said axle of said wheel, said collar having a second axis of rotation substantially perpendicular to said first axis, said apparatus comprising:
a coupling device operationally attached to said flange and a housing;
said housing having a first substantially planar surface, wherein said wheel rotates freely about said first axis of rotation within said housing; and
said housing and said wheel, in combination, rotate freely about said second axis.

20. An apparatus as in claim 19, wherein said first substantially planar surface is a sliding surface.

21. An apparatus as in claim 19, wherein said first substantially planar surface has at least one upturned portion.

22. An apparatus as in claim 19, wherein said first substantially planar surface has one of a skeg and a rudder on an ventral surface thereof.

23. An apparatus as in claim 19, wherein said housing further comprises:
a second substantially planar surface;
a third substantially planar surface;
wherein said second substantially planar surface and said third substantially planar surface are substantially perpendicular to said first axis of rotation.

24. An apparatus as in claim 23, wherein said second substantially planar surface and said third substantially planar surface substantially surround said wheel.

25. An apparatus as in claim 23, wherein said second substantially planar surface and said third substantially planar surface meet in a junction in front of a direction of travel of said wheel.

26. An apparatus as in claim 19, further wherein said first substantially planar surface has a first end and a second end, at least one of said first and second ends having an upturned portion.

27. An apparatus as in claim 23, wherein said first substantially planar surface extends laterally beyond said second and third substantially planar surfaces.

28. An apparatus for attachment to a wheel, said wheel having a first axis of rotation about an axle, said wheel further having a collar attached to a flange operationally attached to said axle of said wheel, said collar having a second axis of rotation perpendicular to said first axis, said apparatus comprising:
a coupling device operationally attached to said flange and to a housing;
said housing having a sliding surface, said sliding surface having an opening therein through which a portion of said wheel extends;
said sliding surface having an upturned portion;
said wheel rotating freely about said first axis of rotation within said housing; and
said housing and said wheel, in combination, rotating freely about said second axis.

29. A coupling device for attachment to a wheel, said wheel having a first axis of rotation about an axle, said wheel further having a collar rotatably attached to a flange operationally attached to said axle of said wheel, said collar having a second axis of rotation substantially perpendicular to said first axis, wherein said coupling device is operatively attached to a wheel housing;
wherein said wheel rotates freely about said first axis of rotation with said wheel housing;
said wheel housing and said wheel, in combination, rotate freely about said second axis; and
wherein said coupling device straddles said flange.

30. A coupling device as in claim 29, wherein said wheel housing has a first planar surface.

31. A wheeled cart comprising:
a container;
a plurality of wheels attached to said container;
at least one sliding surface; and
a coupling device for attaching said at least one sliding surface to said container.

32. A wheeled cart as in claim 31, wherein a wheel housing is attached to said coupling device.

33. A wheeled cart as in claim 32, wherein said wheel housing and said sliding surface are releasably attached to at least one of said plurality of wheels.

34. A wheeled cart as in claim 31, wherein at least two of said plurality of wheels are caster wheels.

35. A wheeled cart as in claim 31, wherein said sliding surface further comprises a plurality of rollers.

36. A wheeled cart comprising:
a plurality of wheels;
a container operatively attached to said plurality of wheels;
said plurality of wheels having a first axis of rotation about an axle, said plurality of wheels further having a collar attached to a flange operationally attached to said axle of said plurality of wheels, said collar having a second axis of rotation substantially perpendicular to said first axis;
a coupling device operatively attached to said flange and to a housing;
said housing having a substantially planar surface;
at least one of said plurality of wheels being able to rotate freely about said first axis of rotation within said housing; and
said housing and at least one of said plurality of wheels, in combination, being able to rotate freely about said second axis.

37. A wheeled cart as in claim 36, wherein at least two of said plurality of wheels have said coupling device and said housing.

38. A wheeled cart as in claim 37, wherein the at least two of said plurality of wheels having said coupling device and said housing are the two front wheels of said cart.

39. A wheeled car as in claim 36, wherein said collar is a bearing.

40. A method to facilitate movement of a cart across a traveling surface comprising:
providing a container;
attaching a plurality of wheels to said container;
providing at least one ski; and
releasably attaching a coupling device to said at least one ski and to at least one of said plurality of wheels.

41. A method as in claim 40, wherein said plurality of wheels are caster wheels.

42. A method as in claim 40, wherein said traveling surface is snow.
